(19) United States
(12) Patent Application Publication
(10) Pub. No.: US 2024/0171905 A1
(43) Pub. Date: May 23, 2024

(54) VOICE LAMP

(71) Applicant: Xiamen Topstar Lighting Co., Ltd., Xiamen (CN)

(72) Inventors: Yongjie WU, Xiamen (CN); Wenda WEN, Xiamen (CN); Ya RAO, Xiamen (CN); Huiwen YAN, Xiamen (CN)

(73) Assignee: Xiamen Topstar Lighting Co., Ltd., Xiamen (CN)

(21) Appl. No.: 18/423,842

(22) Filed: Jan. 26, 2024

(30) Foreign Application Priority Data
Jan. 8, 2024 (CN) 202420041819.1

(51) Int. Cl. H04R 1/34; F21V 3/00; F21V 33/00; H04R 1/02

(52) U.S. Cl. CPC H04R 1/342; F21V 3/00; F21V 33/0056; H04R 1/028

(57) ABSTRACT

A voice lamp includes a radiator, a voice input module, a light emitting assembly, a diffusion cover and a sound guiding tube. The voice input module is electrically connected to the light emitting assembly, and the voice input module and the light emitting assembly are both arranged in the radiator; the diffusion cover is connected to the radiator and covers the outside of the light emitting end of the light emitting assembly; the sound guiding tube is provided through the diffusion cover in the axial direction of the radiator, and the sound guiding tube is directly opposed to the voice input module. According to the application, the sound receiving effect can be improved due to the provision of the sound guiding tube.

### CROSS-REFERENCE TO RELATED APPLICATIONS

This application claims priority to Chinese Patent Application No. 202420041819.1, filed on Jan. 8, 2024, the content of which is incorporated herein by reference in its entirety.

### TECHNICAL FIELD

The application relates to the field of lamps, and in particular to a voice lamp.

### BACKGROUND

In the existing lamp products with voice function, a sound receiving hole is generally provided on a radiator, and a voice input module is provided in the radiator; however, the radiator is usually mounted on a lamp base, so that the sound receiving hole is blocked, thus resulting in a poor sound receiving effect of the lamp, which cannot enable a voice signal to be received in time.

### SUMMARY

The technical problem to be solved by the application is to provide a voice lamp, and improve the sound receiving effect of the lamp.

In order to solve the above technical problem, the technical solution adopted by the application is:
a voice lamp, including a radiator, a voice input module and a light emitting assembly, wherein the voice input module is electrically connected to the light emitting assembly, and the voice input module and the light emitting assembly are both arranged in the radiator, further including a diffusion cover and a sound guiding tube;
wherein the diffusion cover is connected to the radiator and covers the outside of the light emitting end of the light emitting assembly; and
the sound guiding tube is provided through the diffusion cover in the axial direction of the radiator, and the sound guiding tube is directly opposed to the voice input module.

Further, the light emitting assembly includes a light source assembly and a driver electrically connected to the light source assembly;
a sound guiding hole is provided at the position where the light source assembly and the sound guiding tube are directly opposite; and
the voice input module is electrically connected to the driver, and the voice input module is embedded in the sound guiding hole.

Further, an end surface of the sound guiding tube facing the light source assembly is spaced apart from the voice input module in an axial direction of the sound guiding tube.

Further, the sound guiding tube is provided through the sound guiding hole and covers outside the voice input module.

Further, an inner wall of the radiator at an end thereof adjacent the diffusion cover is provided with a limiting boss, and the light source assembly is pressed against the limiting boss.

Further, an output end of the sound guiding tube is embedded in the diffusion cover, and an input end of the sound guiding tube is located outside the diffusion cover and is sealingly connected to an outer surface of the diffusion cover.

Further, an input end of the sound guiding tube is provided with a limiting lip, and the limiting lip is pressed against an outer surface of the diffusion cover.

Further, the sound guiding tube includes a sound receiving section, a transition section, a sound amplifying section and a conducting section arranged in sequence along the axial direction of the sound guiding tube;
an inner diameter of the sound receiving section gradually decreases in a direction gradually approaching the light emitting assembly, an inner diameter of the transition section is equal to a minimum value of the inner diameter of the sound receiving section, and an inner diameter of the sound amplifying section gradually increases in a direction gradually approaching the light emitting assembly; and
an inner diameter of the conducting section is greater than a maximum value of an inner diameter of the sound amplifying section.

Further, a lamp holder is further included, wherein the lamp holder is connected to an end of the radiator remote from the diffusion cover.

The advantageous effect of the application is that by inserting a sound guiding tube on the diffusion cover, the external sound is propagated through the sound guiding tube, and since the sound guiding tube is directly opposite to the voice input module, the sound signal is quickly and accurately recognized by the voice input module. Compared with the prior art, the sound receiving position is changed, so that the sound receiving effect of the lamp is improved.

### BRIEF DESCRIPTION OF THE DRAWINGS

FIG. 1 is a structure schematic view showing one of the voice lamps according to the application.

FIG. 2 is an exploded view of FIG. 1.

FIG. 3 is a cross-sectional view 1 of FIG. 1.

FIG. 4 is a cross-sectional view 2 of FIG. 1.

FIG. 5 is a structure schematic view showing another voice lamp according to the application.

FIG. 6 is an exploded view of FIG. 5.

### DETAILED DESCRIPTION OF THE EMBODIMENTS

In order to explain the technical contents, the objects, and the effects of the application in detail, the embodiments will be described below with reference to the accompanying drawings.

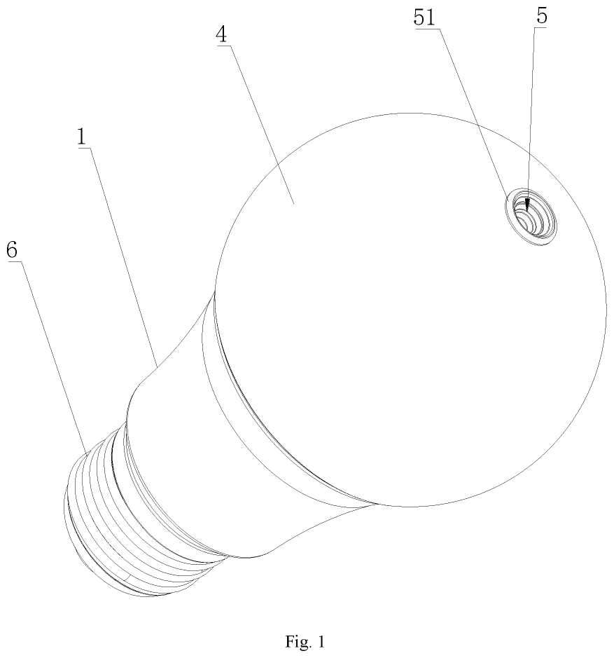

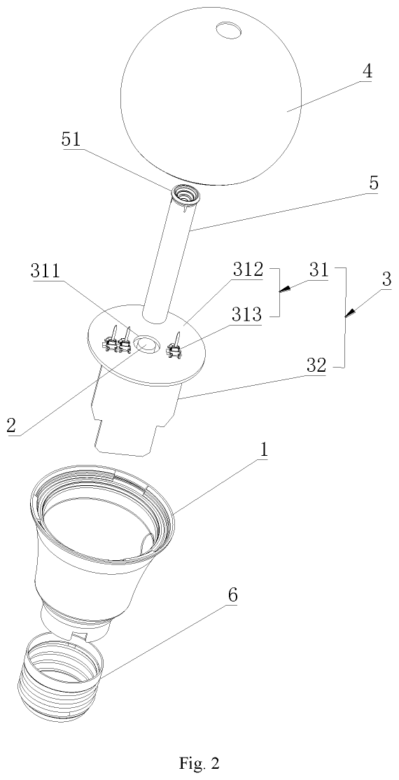

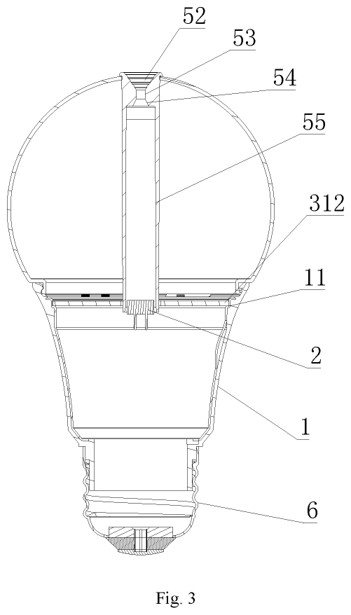

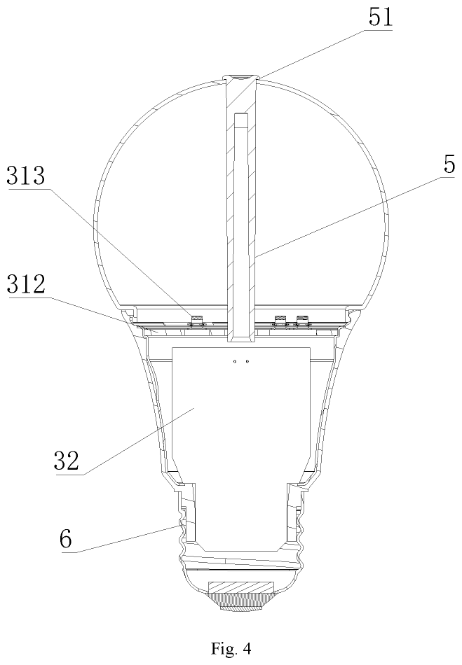

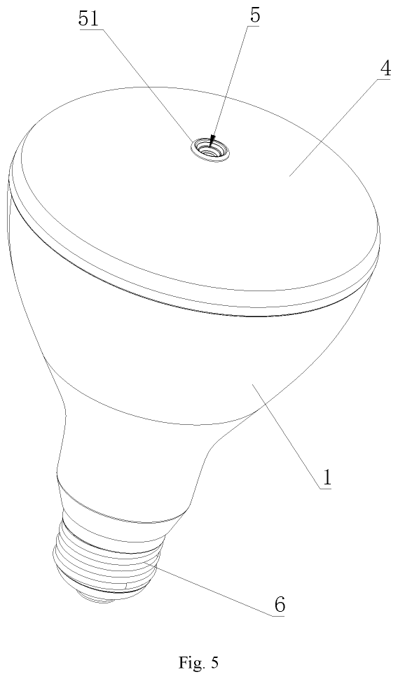

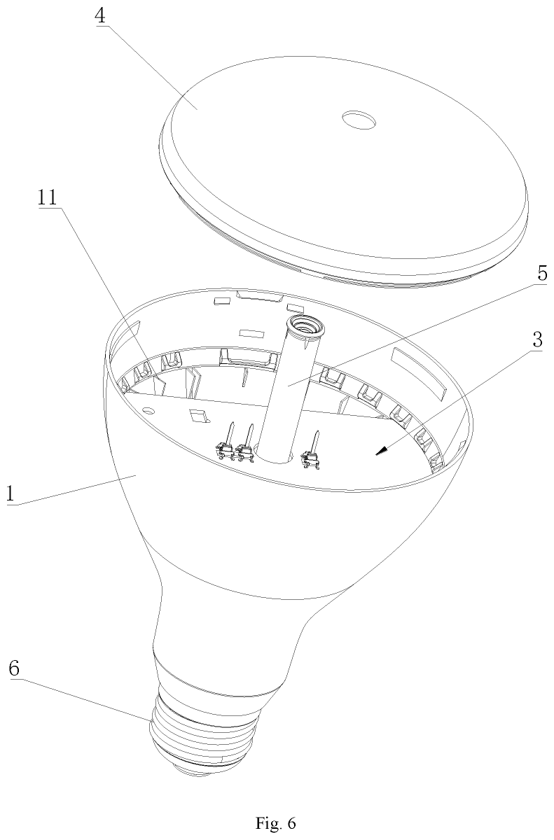

With reference to FIGS. 1-6, a voice lamp includes a radiator 1, a voice input module 2, a light emitting assembly 3, a diffusion cover 4 and a sound guiding tube 5, wherein the voice input module 2 is electrically connected to the light emitting assembly 3, and the voice input module 2 and the light emitting assembly 3 are both arranged in the radiator 1; the diffusion cover 4 is connected to the radiator 1 and covers outside the light emitting end of the light emitting assembly 3; a sound guiding tube 5 is provided through the diffusion cover 4 in the axial direction of the radiator 1, and the sound guiding tube 5 is directly opposed to the voice input module 2. Wherein, the diffusion cover 4 may be of various shapes, such as a sphere-like shape, a cone-like shape, a flat shape, etc.

As can be understood, by inserting the sound guiding tube 5 on the diffusion cover 4, the external sound is propagated through the sound guiding tube 5, and since the sound guiding tube 5 is directly opposed to the voice input module 2, the sound signal is quickly and accurately recognized by the voice input module 2. Compared with the prior art, the sound receiving position is changed, so that the sound receiving effect of the lamp is improved.

In some embodiments, the light emitting assembly 3 includes a light source assembly 31 and a driver 32 electrically connected to the light source assembly 31; a sound guiding hole 311 is provided at a position where the light source assembly 31 and the sound guiding tube 5 are directly opposite; the voice input module 2 is electrically connected to the driver 32, and the voice input module 2 is embedded in the sound guiding hole 311. The sound signal received by the voice input module 2 is subjected to signal conversion and transmitted to the driver 32, and the driver 32 executes a corresponding instruction to realize automatic control on the light source assembly 31 and improve the intelligent level. Specifically, the light source assembly 31 includes a light source plate 312 and a plurality of light emitting members 313, wherein the sound guiding holes 311 are provided on the light source plate 312, and the light emitting members 313 are arranged on a side of the light source plate 312 facing the diffusion cover 4, so that the light generated by the light emitting members 313 is diffused through the diffusion cover 4, and the diffusion cover 4 serves to improve the lighting effect.

In some embodiments, an end surface of the sound guiding tube 5 close to the light source assembly 31 is spaced apart from the voice input module 2 in an axial direction of the sound guiding tube 5.

In some embodiments, the sound guiding tube 5 is provided through the sound guiding hole 311 and covers outside the voice input module 2. The sound guiding tube 5 covers outside the voice input module 2, so that the sound signal is completely received by the voice input module 2, and the recognition accuracy is improved.

In some embodiments, the inner wall of the radiator 1 at an end thereof adjacent the diffusion cover 4 is provided with a limiting boss 11, and the light source assembly 31 is pressed against the limiting boss 11. Preferably, the light source assembly 31 is in an interference fit with the inner wall of the diffuser, and the light source assembly 31 can be connected to the diffuser by means of adhesion. The arrangement of the limiting boss 11 is used for limiting the light source assembly 31 and improving the structural stability.

In some embodiments, an output end of the sound guiding tube 5 is embedded in the diffusion cover 4, and an input end of the sound guiding tube 5 is located outside the diffusion cover 4 and is sealingly connected to an outer surface of the diffusion cover 4, so that sound can only propagate to the voice input module 2 via the sound guiding tube 5.

In some embodiments, the input end of the sound guiding tube 5 has a limiting lip 51, the limiting lip 51 is pressed against the outer surface of the diffusion cover 4, and the limiting lip 51 is provided to limit the position of the sound guiding tube 5 so as to maintain a stable positional relationship between the sound guiding tube 5 and the diffusion cover 4.

In some embodiments, the sound guiding tube 5 includes a sound receiving section 52, a transition section 53, a sound amplifying section 54 and a conducting section 55 arranged in sequence along the axial direction of the sound guiding tube 5; the inner diameter of the sound receiving section 52 gradually decreases along the direction gradually approaching the light emitting assembly 3, the inner diameter of the transition section 53 is equal to the maximum value of the inner diameter of the sound receiving section 52, and the inner diameter of the sound amplifying section 54 gradually increases along the direction gradually approaching the light emitting assembly 3; the inner diameter of the conducting section 55 is greater than the maximum value of an inner diameter of the sound amplifying section 54. The arrangement of the sound receiving section 52 and the sound amplifying section 54 can respectively form a horn shape arranged in different directions, wherein the sound receiving section 52 serves to enhance the reception of sound signals, and the sound amplifying section 54 serves to amplify sound, so that the sound is propagated through the conducting section 55 after amplification, thereby improving the sound receiving effect.

In some embodiments, a lamp holder 6 is also included, wherein the lamp holder 6 is connected to an end of the radiator 1 remote from the diffusion cover 4, the lamp holder 6 is used for electrically connected to a lamp base for powering the light source assembly 31 and the voice input module 2.

Referring to FIGS. 1-6, Embodiment 1 of the application is as follows.

A voice lamp includes a radiator 1, a voice input module 2, a light emitting assembly 3, a diffusion cover 4 and a sound guiding tube 5, wherein the voice input module 2 is electrically connected to the light emitting assembly 3, and the voice input module 2 and the light emitting assembly 3 are both arranged in the radiator 1; the diffusion cover 4 is connected to the radiator 1 and covers outside the light emitting end of the light emitting assembly 3; a sound guiding tube 5 is provided through the diffusion cover 4 in the axial direction of the radiator 1, and the sound guiding tube 5 is directly opposed to the voice input module 2.

In the embodiment, the light emitting assembly 3 includes a light source assembly 31 and a driver 32 electrically connected to the light source assembly 31; a sound guiding hole 311 is provided at a position where the light source assembly 31 and the sound guiding tube 5 are directly opposite; the voice input module 2 is electrically connected to the driver 32, and the voice input module 2 is embedded in the sound guiding hole 311; the light source assembly 31 includes a light source plate 312 and a plurality of light emitting members 313, wherein the sound guiding holes 311 are provided on the light source plate 312, and the light emitting members 313 are arranged on a side of the light source plate 312 facing the diffusion cover 4; the sound guiding tube 5 is provided through the sound guiding hole 311 and covers outside the voice input module 2.

In the embodiment, an output end of the sound guiding tube 5 is embedded in the diffusion cover 4, an input end of the sound guiding tube 5 is located outside the diffusion cover 4 and is sealingly connected to an outer surface of the diffusion cover 4, and specifically, the input end of the sound guiding tube 5 is provided with a limiting lip 51, and the limiting lip 51 is pressed against the outer surface of the diffusion cover 4.

In the embodiments, the sound guiding tube 5 includes a sound receiving section 52, a transition section 53, a sound amplifying section 54 and a conducting section 55 arranged in sequence along the axial direction of the sound guiding tube 5; the inner diameter of the sound receiving section 52 gradually decreases along the direction gradually approaching the light emitting assembly 3, the inner diameter of the transition section 53 is equal to the minimum value of the inner diameter of the sound receiving section 52, and the inner diameter of the sound amplifying section 54 gradually increases along the direction gradually approaching the light emitting assembly 3; the inner diameter of the conducting section 55 is greater than the maximum value of an inner diameter of the sound amplifying section 54. Here, the minimum value of the inner diameter of the sound receiving section 52 is equal to the minimum value of the inner diameter of the sound amplifying section 54, and therefore, the inner diameter of the transition section 53 is equal to both the maximum value of the inner diameter of the sound receiving section 52 and the minimum value of the inner diameter of the sound amplifying section 54.

In the embodiment, a lamp holder 6 is further included, and the lamp holder 6 is connected to an end of the radiator 1 remote from the diffusion cover 4.

The above description is only an embodiment of the application, and is not intended to limit the scope of the application, and all equivalent transformation performed by using the contents of the specification and the drawings of the application or directly or indirectly applied to the related technical fields are included in the scope of the application.

What is claimed is:

1. A voice lamp, comprising a radiator, a voice input module, a light emitting assembly, a diffusion cover and a sound guiding tube, wherein
the voice input module is electrically connected to the light emitting assembly, and the voice input module and the light emitting assembly are both arranged in the radiator;
the diffusion cover is connected to the radiator and covers the outside of the light emitting end of the light emitting assembly; and
the sound guiding tube is provided through the diffusion cover in the axial direction of the radiator, and the sound guiding tube is directly opposed to the voice input module.

2. The voice lamp according to claim 1, wherein the light emitting assembly comprises a light source assembly and a driver electrically connected to the light source assembly;
a sound guiding hole is provided at the position where the light source assembly and the sound guiding tube are directly opposite; and
the voice input module is electrically connected to the driver, and the voice input module is embedded in the sound guiding hole.

3. The voice lamp according to claim 2, wherein the sound guiding tube is provided through the sound guiding hole and covers outside the voice input module.

4. The voice lamp according to claim 2, wherein an end surface of the sound guiding tube facing the light source assembly is spaced apart from the voice input module in an axial direction of the sound guiding tube.

5. The voice lamp according to claim 2, wherein an inner wall of the radiator at an end thereof adjacent the diffusion cover is provided with a limiting boss, and the light source assembly is pressed against the limiting boss.

6. The voice lamp according to claim 1, wherein an output end of the sound guiding tube is embedded in the diffusion cover, and an input end of the sound guiding tube is located outside the diffusion cover and is sealingly connected to an outer surface of the diffusion cover.

7. The voice lamp according to claim 1, wherein an input end of the sound guiding tube is provided with a limiting lip, and the limiting lip is pressed against an outer surface of the diffusion cover.

8. The voice lamp according to claim 1, wherein the sound guiding tube comprises a sound receiving section, a transition section, a sound amplifying section and a conducting section arranged in sequence along the axial direction of the sound guiding tube;
an inner diameter of the sound receiving section gradually decreases in a direction gradually approaching the light emitting assembly, an inner diameter of the transition section is equal to a minimum value of the inner diameter of the sound receiving section, and an inner diameter of the sound amplifying section gradually increases in a direction gradually approaching the light emitting assembly; and
an inner diameter of the conducting section is greater than a maximum value of the inner diameter of the sound amplifying section.

9. The voice lamp according to claim 1, further comprising a lamp holder, wherein the lamp holder is connected to an end of the radiator remote from the diffusion cover.
